(19) United States
(12) Patent Application Publication
(10) Pub. No.: US 2007/0114165 A1
(43) Pub. Date: May 24, 2007

(54) Fuel filter

(76) Inventor: Andrew E. Buczynsky, Brownstown, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/285,717

(22) Filed: Nov. 21, 2005

(51) Int. Cl. B01D 15/00

(52) U.S. Cl. 210/263

(57) ABSTRACT

A method and apparatus configured to remove impurities from fuel is provided. The apparatus includes a housing disposed between a fuel tank and a diesel engine of the diesel powered vehicle. The housing defines a main body, an inlet port disposed at an end portion of the main body, and an outlet port disposed at an opposite end portion of the main body. A fuel diffuser is disposed within the main body of the housing and is in fluid communication with the inlet port. A fuel collector is disposed within the main body of the housing and is in fluid communication with the outlet port. A molecular sieve is disposed within the main body of the housing between the fuel diffuser and the fuel collector. The molecular sieve is adapted to remove impurities such as water from the fuel such that purified fuel is transferred to the engine and vehicle performance is improved.

### TECHNICAL FIELD

The present invention is drawn to a method and apparatus adapted to remove impurities from fuel.

### BACKGROUND OF THE INVENTION

Diesel powered vehicles generally include a diesel fuel water separator to prevent water from entering the engine and to optimize vehicle performance. Conventional diesel fuel water separators contain filtration elements made of cellulose that has been chemically modified to induce water coalescence. However, these conventional separators may be rendered ineffective by large amounts of polar materials that are soluble in diesel fuel such as, for example, detergent additives and biodiesel additives.

### SUMMARY OF THE INVENTION

The present invention includes a method and apparatus configured to remove impurities from fuel. The method and apparatus of the present invention implement a molecular sieve adapted to remove impurities such as water from the fuel and which is not rendered ineffective by polar materials. As is known in the art, polar materials are materials composed of molecules having a permanent electric dipole moment.

According to a preferred embodiment, the apparatus includes a housing disposed between a fuel tank and a diesel engine of the diesel powered vehicle. The housing defines a generally cylindrical main body, an inlet port disposed at an end portion of the main body, and an outlet port disposed at an opposite end portion of the main body. A fuel diffuser is disposed within the main body of the housing and is in fluid communication with the inlet port. A fuel collector is disposed within the main body of the housing and is in fluid communication with the outlet port. A molecular sieve is disposed within the main body of the housing between the fuel diffuser and the fuel collector. According to the preferred embodiment, the outlet port of the housing is attached to a cellulose filter.

According to one aspect of the invention, the molecular sieve is a type 3A molecular sieve adapted to filter water from the fuel.

According to another aspect of the invention, the molecular sieve is a type 4A molecular sieve adapted to filter water from the fuel.

According to yet another aspect of the invention, the housing is composed of injection molded plastic such that cost and weight are minimized.

A preferred method of the present invention includes transferring fuel from a fuel tank to a filter apparatus such as, for example, with a fuel pump. The fuel in the filter apparatus is then diffused to increase the flow area. The diffused fuel is then filtered through a molecular sieve within the filter apparatus to remove impurities such as water. Thereafter, the fuel is transferred from the filter apparatus to the engine.

According to one aspect of the invention, the fuel is transferred to a collector or reservoir prior to transferring the fuel to the engine.

According to another aspect of the invention, the fuel is transferred through a cellulose filter prior to transferring the fuel to the engine.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic diagram of a vehicle having a diesel fuel water filter apparatus according to the present invention; and

FIG. 2 is a more detailed schematic diagram of the diesel fuel water filter apparatus of FIG. 1.

### DESCRIPTION OF THE PREFERRED EMBODIMENTS

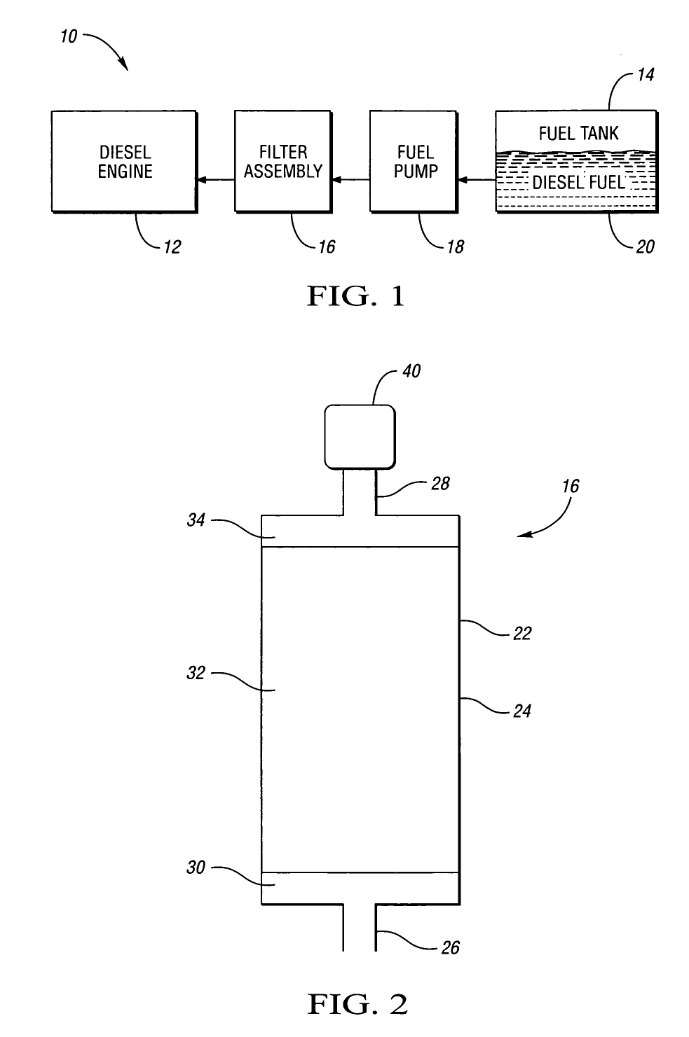

Referring to the drawings, wherein like reference numbers refer to like components, FIG. 1 shows a schematic depiction of a diesel powered vehicle 10 according to a preferred embodiment of the present invention. The vehicle 10 includes a diesel engine 12, a fuel tank 14, and a filter assembly 16 disposed therebetween. A fuel pump 18 is adapted to transfer diesel fuel 20 from the fuel tank 14, through the filter assembly 16, and to the diesel engine 12. It should be appreciated that the fuel pump 18 is shown disposed between the fuel tank 14 and the filter assembly 16 for exemplary purposes; however, the fuel pump 18 may alternatively be disposed in other locations such as, for example, within the fuel tank 14. The filter assembly 16 is configured to remove water from the diesel fuel 20 to protect the diesel engine 12 and optimize performance of the vehicle 10.

Referring to FIG. 2, the filter assembly 16 is shown in more detail. The filter assembly 16 includes a housing or cartridge 22. The housing 22 is preferably composed of injection molded plastic to minimize the cost and weight of the filter assembly 16. Alternatively, the housing 22 may be composed of any conventional material such as, for example, metal. The housing 22 defines a generally cylindrical main body 24, an inlet port 26, and an outlet port 28. The inlet port 26 and outlet port 28 are preferably disposed at opposite end portions of the main body 24. A fuel diffuser 30, a molecular sieve 32, and a fuel collector 34 are preferably disposed within the main body 24 of the housing 22. The fuel diffuser 30 is disposed within the main body 24 near the inlet port 26 and is in fluid communication therewith. The fuel collector 34 is disposed within the main body 24 near the outlet port 28 and is in fluid communication therewith. The molecular sieve 32 is disposed within the main body 24 between the fuel diffuser 30 and the fuel collector 34.

The fuel diffuser 30 is preferably a conventional nozzle design, and is adapted to increase the flow area of the diesel fuel 20 (shown in FIG. 1) such that the fuel 20 is distributed more evenly across the surface of the molecular sieve 32. It has been observed that, by distributing the fuel 20 across a larger molecular sieve surface area with the diffuser 30, more water may be filtered from the fuel 20 and the life of the filter assembly 16 may be prolonged.

According to a preferred embodiment, the molecular sieve 32 is composed of adsorbent materials such as aluminosilicate crystalline polymers, or zeolites (not shown). It should be appreciated, however, that the molecular sieve 32 may alternatively include other compositions such as, for example, a synthetic molecular sieve. The zeolites form a three-dimensional interconnecting network having a plurality of well defined openings or pores (not shown). Molecules that fit into the pores are filtered out or trapped as they flow across the filter, whereas larger molecules are allowed to pass through. The molecular sieve 32 is preferably a type 3A or 4A molecular sieve which has pores that are sized to filter out water molecules. As is known in the art, “type 3A” and “type 4A” are common manufacturing designations for molecular sieves.

The molecular sieve 32 is thereby configured to remove water from diesel fuel and biodiesel without removing larger diesel fuel, biodiesel, or fuel additive molecules. Additionally, the filter assembly 16 is not rendered inactive by polar materials, and will continue to remove water from the diesel fuel 20 (shown in FIG. 1) until the molecular sieve 32 is saturated. As is known in the art, polar materials are materials composed of molecules having a permanent electric dipole moment. After the molecular sieve 32 becomes saturated, it may be recharged in a conventional manner to remove the water therefrom. One method for recharging a saturated molecular sieve includes washing the sieve with a solvent adapted for such a purpose, drying the sieve, and thereafter heating the sieve at approximately 200 degrees Centigrade for several hours.

The fuel collector 34 is preferably a reservoir or container adapted to hold the fuel 20 transferred through the molecular sieve 32 before the diesel fuel 20 passes through the outlet port 28.

According to a preferred embodiment of the present invention, the water filter 16 includes a cellulose filter 40 attached to the output port 28 of the housing 22. The cellulose filter 40 is preferably implemented as a precautionary measure in case the molecular sieve 32 breaks down. More precisely, the cellulose filter 40 is implemented to prevent the constituent materials of a broken down molecular sieve from reaching the engine 12 (shown in FIG. 1).

While the best modes for carrying out the invention have been described in detail, those familiar with the art to which this invention relates will recognize various alternative designs and embodiments for practicing the invention within the scope of the appended claims.

1. A filter apparatus for a vehicle, the vehicle having an engine in fluid communication with a fuel tank, said filter apparatus comprising:
a housing configured to be disposed between the engine and the fuel tank, with the housing being in fluid communication with the fuel tank and the engine such that fuel from the fuel tank passes through the housing before reaching the engine; and
a molecular sieve disposed within the housing, wherein the molecular sieve is configured to remove impurities from the fuel before the fuel is transferred to the engine.

2. The filter apparatus of claim 1, wherein the housing defines a main body, an inlet port disposed at an end portion of the main body, and an outlet port disposed at an opposite end portion of the main body.

3. The filter apparatus of claim 2, further comprising a fuel diffuser disposed within the main body of the housing in fluid communication with the inlet port;

4. The filter apparatus of claim 3, further comprising a fuel collector disposed within the main body of the housing in fluid communication with the outlet port.

5. The filter apparatus of claim 4, further comprising a cellulose filter attached to the outlet port of the housing.

6. The filter apparatus of claim 1, wherein the molecular sieve is a type 3A molecular sieve adapted to remove water from the fuel.

7. The filter apparatus of claim 1, wherein the molecular sieve is a type 4A molecular sieve adapted to remove water from the fuel.

8. The filter apparatus of claim 1, wherein the housing is composed of injection molded plastic to minimize the cost and weight of the filter apparatus.

9. A filter apparatus for a vehicle, said vehicle having an engine in fluid communication with a fuel tank, said filter apparatus comprising:
a housing configured to be disposed between the engine and the fuel tank, said housing defining a main body, an inlet port disposed at an end portion of the main body, and an outlet port disposed at an opposite end portion of the main body;
a fuel diffuser disposed within the main body of the housing in fluid communication with the inlet port;
a fuel collector disposed within the main body of the housing in fluid communication with the outlet port; and
a molecular sieve disposed within the main body of the housing between the fuel diffuser and the fuel collector, wherein said molecular sieve is configured to remove impurities from the fuel before the fuel is transferred to the diesel engine.

10. The filter apparatus of claim 9, further comprising a cellulose filter attached to the outlet port of the housing.

11. The filter apparatus of claim 9, wherein the molecular sieve is a type 3A molecular sieve adapted to remove water from the fuel.

12. The filter apparatus of claim 9, wherein the molecular sieve is a type 4A molecular sieve adapted to remove water from the fuel.

13. The filter apparatus of claim 9, wherein the housing is composed of injection molded plastic to minimize the cost and weight of the filter apparatus.

14. A method for providing purified fuel to an engine in a vehicle, said method comprising:
transferring fuel from a fuel tank to a filter apparatus;
diffusing the fuel in the filter apparatus to increase the flow area;
filtering the diffused fuel through a molecular sieve in the filter apparatus to remove impurities; and
transferring the purified fuel from the filter apparatus to the engine.

15. The method of claim 14, further comprising collecting the purified fuel in a reservoir before transferring the fuel to the engine.

16. The method of claim 14, further comprising transferring the purified fuel through a cellulose filter before transferring the fuel to the engine.

17. The method of claim 14, wherein filtering the fuel through a molecular sieve includes filtering the fuel through a type 3A molecular sieve to remove water from the fuel.

18. The method of claim 14, wherein filtering the fuel through a molecular sieve includes filtering the fuel through a type 4A molecular sieve to remove water from the fuel.
